(19) United States
(12) Patent Application Publication
(10) Pub. No.: US 2012/0204438 A1
(43) Pub. Date: Aug. 16, 2012

(54) Chalk Marking Device

(76) Inventor: Matthew Seaver, Dunedin, FL (US)

(21) Appl. No.: 13/371,844

(22) Filed: Feb. 13, 2012

Related U.S. Application Data
(60) Provisional application No. 61/442,917, filed on Feb. 15, 2011.

(51) Int. Cl. B25H 7/04

(52) U.S. Cl. 33/666

(57) ABSTRACT

An improved chalk marking device for safely and temporarily marking a surface. The improved chalk marking device is capable of making precise temporary markings on a surface, and will not prematurely deteriorate upon use. The improved chalk marking device also contains a non-toxic taste inhibiting agent that will prevent or reduce the likelihood that an individual, such as a young child or infant, will ingest the device if left unattended.

### CROSS-REFERENCE

This application claims priority from Provisional Patent Application Ser. No. 61/442,917 filed Feb. 15, 2011.

### FIELD OF THE INVENTION

This invention relates to an improved chalk marking device that enables a user to temporarily mark surfaces in a safe and effective manner, and for a prolonged period of time before having to replace said chalk marking device.

### BACKGROUND

Chalk, typically in the form of a wafer, block, pen or other marking instrument, is commonly used to temporarily mark surfaces such as blackboards, wood, plastic, metal, clothing and the like. The benefits of such a marking method is that once the chalk marking or line is no longer required, it can be easily removed from the marked article by the user.

One common type of chalk is blackboard chalk, which is typically used to mark hard surfaces. More specifically, when used, blackboard chalk readily crumbles leaving chalk particles that stick loosely to the surfaces being marked. Although traditionally comprised of natural chalk (i.e., calcium carbonate), modern blackboard chalk is now more commonly comprised of the mineral gypsum (i.e., calcium sulfate), and is often offered for sale in the form of a block, stick or wafer of compressed gypsum powder.

Another type of commonly used chalk is oftentimes referred to as tailor's chalk, which is a relatively hard chalk used to make temporary markings on cloth, mainly by tailors. Nowadays, tailor's chalk is made from talc (i.e., magnesium silicate) and is typically offered for sale in wafer-like form.

One limitation oftentimes associated with the use of chalk, such as blackboard chalk, as a marking agent is the fact that the chalk marking device will crumble relatively easily thereby making it difficult to make precise markings, as the chalk marking edge or point is worn away from moving the chalk marking device across the relatively hard surface. Consequently, there exists a long-felt need in the art for a chalk marking device that also comprises a hardening agent that enables the chalk marking device to be both effective and capable of withstanding repeated use with minimal deformation or degradation.

Another limitation typically associated with the use of blackboard or tailor's chalk is that it can be toxic if ingested in certain quantities. More specifically, children, and particularly young children, are oftentimes known to pick up articles left lying around and put those articles in their mouths. Such children, or other individuals, could become ill if they consume excess quantities of chalk from, for example, an unattended chalk marker. Consequently, there also exists a long-felt need in the art for a chalk marking device that further comprises a non-toxic taste inhibiting agent that will discourage children and other individuals from consuming more than a minimal amount of chalk.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an improved chalk marking device that enables a user to temporarily and precisely mark surfaces in a safe and effective manner without substantially deteriorating the surface of the marking device. In a preferred embodiment of the present invention, the improved chalk marking device is comprised of a chalk wafer that is further comprised of a hardening agent for prolonging the useful life of the chalk marking device, and a non-toxic taste inhibiting agent that will prevent or reduce the likelihood that an individual, such as a young child or infant, will ingest the chalk marking device if the same is left unattended.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one embodiment of the chalk marking device of the present invention.

FIG. 2 illustrates a perspective view of an alternative embodiment of the chalk marking device of the present invention.

FIG. 3 illustrates a perspective view of one embodiment of the chalk marking device being used to temporarily mark the surface of a board.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

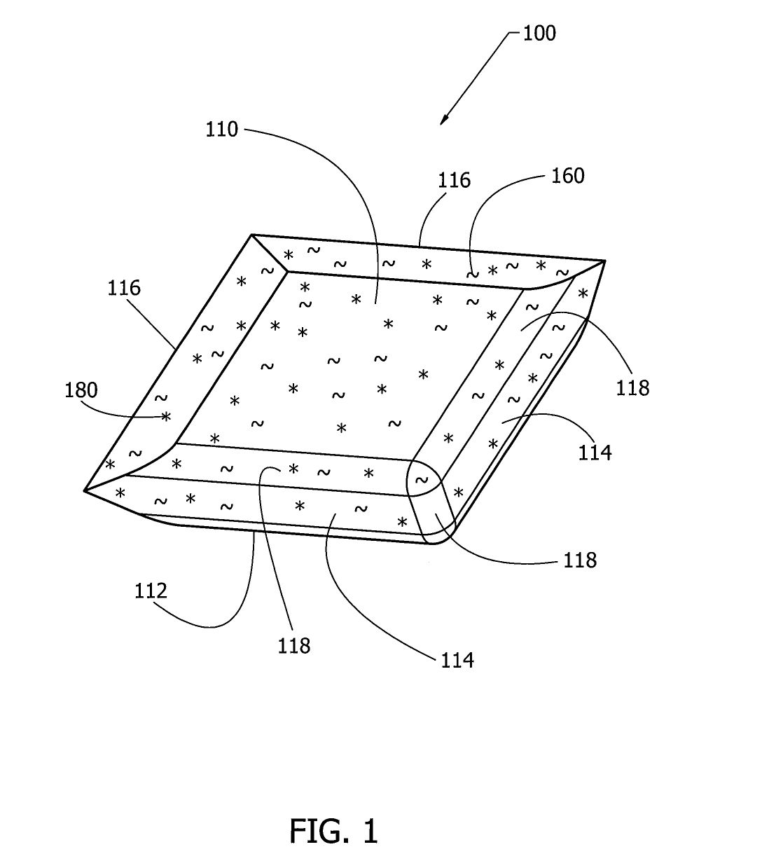

Referring initially to the drawings, FIG. 1 illustrates but one embodiment of the chalk marking device 100 of the present invention, which is primarily comprised of calcium sulfate and is generally in the form of a square or rectangle wafer, though virtually any other geometric or abstract shape could also be used. It is also contemplated that chalk marking device 100 can be comprised of other commonly known ingredients, such as calcium carbonate, talc and the like, without affecting the overall concept of the present invention.

As depicted in the FIGURES, chalk marking device 100 preferably comprises a top surface 110, a bottom surface 112, at least one side surface 114 and at least one pointed surface or edge 116 for making precise markings on an object such as a blackboard, wood, plastic, metal, clothing and the like. Other edges connecting top surface 110 or bottom surface 114 with side surfaces 114 are rounded or with radiuses 118 as shown in the FIGURES. While chalk marking device 100 can be sized according to user preference, the chalk marking device 100 depicted in FIG. 1 is preferably between ½ and 4 inches in length, ½ and 4 inches in width, and ¼ and ¾ of an inch in thickness measured from top surface 110 to bottom surface 112 for easily handling and maneuverability.

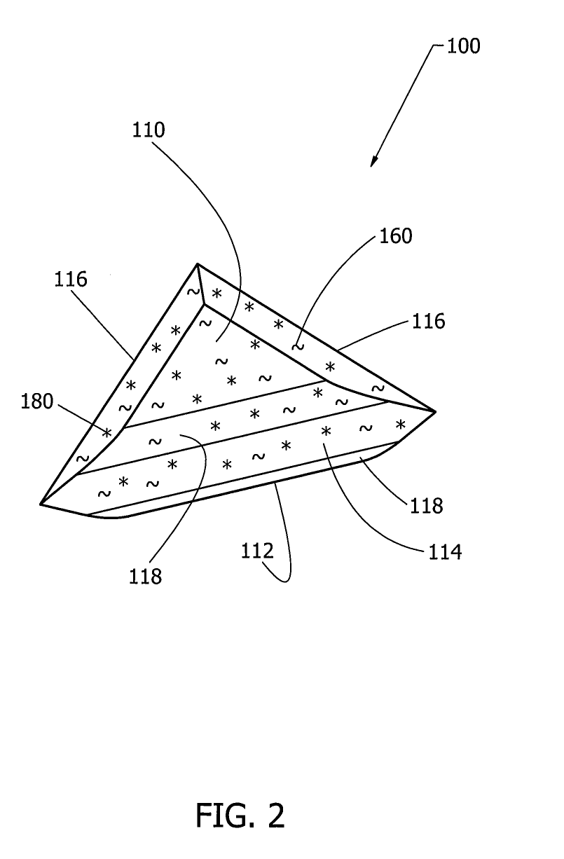

FIG. 2 illustrates a second embodiment of the chalk marking device 100 of the present invention, which is primarily comprised of calcium sulfate and generally in the form of a triangle though, as previously mentioned, virtually any other geometric or abstract shape can be used. For example, it is also contemplated that chalk marking device could be in the general shape of a crayon or marker without affecting the overall concept of the present invention. Further, while chalk marking device 100 can be sized according to user preference, the chalk marking device 100 depicted in FIG. 2 is also preferably between ½ and 4 inches in length, ½ and 4 inches in width, and ¼ and ¾ of an inch in thickness measured from top surface 110 to bottom surface 112.

As an important aspect of the present invention, chalk marking device 100 is preferably further comprised of a taste inhibiting agent 160 and/or a hardening agent 180. Taste inhibiting agent 160 can be any non-toxic substance that, due to its taste or smell, will prevent or reduce the likelihood of a child or other individual from ingesting more than a minimal amount of chalk marking device 100. For example, and without limitation, taste inhibiting agent 160 can be jalapeno or other hot pepper juice, Tabasco®, or a liquid solution containing black pepper and water and/or juice, each of which has a somewhat undesirable taste and should cause the child, or other individual, who picks up an unattended chalk marking device 100 from placing or further placing the device in their mouth. It is contemplated that taste inhibiting agent 160 should comprise between 0 and 60 percent of the overall weight of chalk marking device 100 to serve as a proper deterrent.

As previously mentioned, chalk marking device 100 may also include a hardening agent 180. Hardening agent 180 can be any commonly known hardening agent, such as, without limitation, soda silicate, gypsum cement, plaster of paris and/or a baked tree sap liquid. The purpose of hardening agent 180 is to prevent the premature degradation of chalk marking device 100 and, more particularly, the at least one pointed surface or edge 116. As stated supra, existing chalk marking devices, are typically comprised of gypsum, which crumbles relatively easily thereby making it difficult to make precise markings, as the chalk marking edge or point is worn away from moving the chalk marking device across the relatively hard surface. The addition of hardening agent 180 will reduce the crumbling of chalk marking device 100 and prolong its useful life. It is contemplated that hardening agent 180 should comprise between 0 and 60 percent of the overall weight of chalk marking device 100 to serve its intended purpose.

Chalk marking device 100 is preferably white in color, though virtually any color could be used without affecting the overall concept of the present invention. For example, if the surface to be marked is white in color, it would be advantageous to use, for example, a colored chalk marking device 100, such as red, blue, green, yellow, black, etc., as is commonly known in the art.

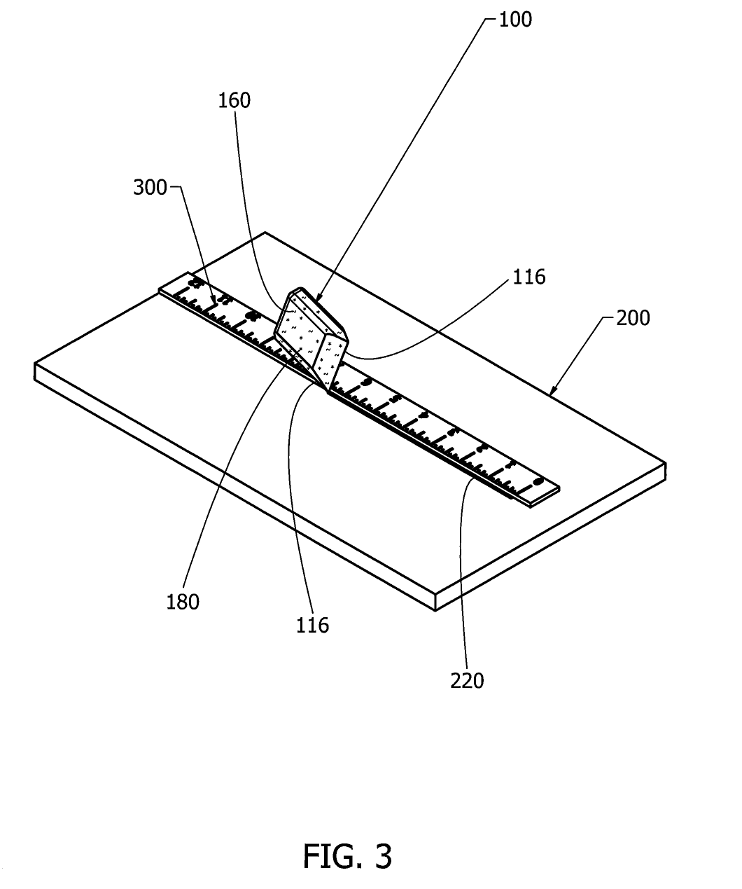

Having now described multiple embodiments of chalk marking device 100, its use and usefulness will now be further described. FIG. 3 illustrates a perspective view of chalk marking device 100 being used to temporarily mark the surface of a board 200. More specifically, a user (not shown) desiring to place a straight line on board 200 could properly position a ruler 300 or other straight edge on board 200, and slide the pointed surface or edge 116 of chalk marking device 100 across board 200 and against ruler 300. Despite the presence of hardening agent 180, chalk marking device 100 will leave a precise and removable marking 220 on board 200 in the desired location. Additionally, marking 220 can easily be removed from board 200, or any other marked surface, by wiping the same with a damp cloth (not shown) when said marking is no longer required.

Further, the presence of hardening agent 180 should enable the user (not shown) to make multiple markings 220 with chalk marking device 100 and, more particularly, pointed surface or edge 116 with relatively minimal degradation thereto. Additionally, the presence of non-toxic taste inhibiting agent 160 should prevent or reduce the likelihood that a child or other individuals will consume chalk marking device 100 if is left unattended.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A chalk marking device comprising:
a hardening agent; and
a taste inhibiting agent.

2. The chalk marking device of claim 1 wherein said hardening agent is comprised of at least one of the following: soda silicate, gypsum cement, tree sap or plaster.

3. The chalk marking device of claim 1 wherein said hardening agent comprises between 0 and 60 percent of the overall weight of the chalk marking device.

4. The chalk marking device of claim 1 wherein said taste inhibiting agent is comprised of at least one of the following: Tabasco®, jalapeno juice, or a liquid solution containing black pepper.

5. The chalk marking device of claim 1 wherein said taste inhibiting agent comprises between 0 and 60 percent of the overall weight of the chalk marking device.

6. The chalk marking device of claim 1, wherein said chalk marking device has at least one pointed surface for marking an object.

7. The chalk marking device of claim 1 further comprising calcium sulfate.

8. A chalk marking device comprising:
a hardening agent;
a taste inhibiting agent; and
at least one pointed surface for marking an object.

9. The chalk marking device of claim 8 wherein said hardening agent is comprised of at least one of the following: soda silicate, gypsum cement, tree sap or plaster.

10. The chalk marking device of claim 8 wherein said hardening agent comprises between 0 and 60 percent of the overall weight of the chalk marking device.

11. The chalk marking device of claim 8 wherein said taste inhibiting agent is comprised of at least one of the following: Tabasco®, jalapeno juice, or a liquid solution containing black pepper.

12. The chalk marking device of claim 8 wherein said taste inhibiting agent comprises between 0 and 60 percent of the overall weight of the chalk marking device.

13. The chalk marking device of claim 8 further comprising calcium sulfate.

14. A chalk marking device comprising:
a hardening agent;
a taste inhibiting agent, wherein said taste inhibiting agent comprises between 0 and 60 percent of the overall weight of the chalk marking device; and
at least one pointed surface for marking an object.

15. The chalk marking device of claim 14 wherein said hardening agent is comprised of at least one of the following: soda silicate, gypsum cement, tree sap or plaster.

16. The chalk marking device of claim 14 wherein said taste inhibiting agent is comprised of at least one of the following: Tabasco®, jalapeno juice, or a liquid solution containing black pepper.

17. The chalk marking device of claim 14 wherein said hardening agent comprises between 0 and 60 percent of the overall weight of the chalk marking device.

18. The chalk marking device of claim 14 further comprising calcium sulfate.

19. The chalk marking device of claim 14, wherein said chalk marking device has at least one pointed surface for marking an object.

20. The chalk marking device of claim 14 further comprising talc.
